(19) United States
(12) Patent Application Publication
(10) Pub. No.: US 2018/0042199 A1
(43) Pub. Date: Feb. 15, 2018

(54) LITTER CLEANING AND DISPOSAL SYSTEM

(71) Applicant: Colleen Smith, Amsterdam, NY (US)

(72) Inventor: Colleen Smith, Amsterdam, NY (US)

(21) Appl. No.: 15/235,210

(22) Filed: Aug. 12, 2016

(51) Int. Cl. A01K 1/01

(52) U.S. Cl. CPC A01K 1/0114

(57) ABSTRACT

Embodiments of the invention relate generally to cleaning and disposal systems and, more particularly, to a system for cleaning and disposing of animal litter. In one embodiment, the invention provides a cleaning and disposal system, the system comprising: a liner device having a substantially continuous surface; and at least one perforated device having: a perforated portion having a plurality of openings; and a substantially continuous portion surrounding the perforated portion.

### BACKGROUND OF THE INVENTION

Embodiments of the invention relate generally to cleaning and disposal systems and, more particularly, to a system for cleaning and disposing of animal litter.

Cleaning and disposing of animal litters, such as cat litter, is an unpleasant and often messy task. Doing so typically involves bending over a litter box and scooping clumped, soiled litter from unsoiled litter and then depositing the clumped, soiled litter into a bag or other receptacle for disposal. Often, soiled or unsoiled litter is spilled outside the litter box in doing so.

This process can also be hazardous. Toxoplasmosis is a parasitic infection found in birds, animals, and people caused by Toxoplasma gondii, a parasitic protozoan. In adult humans, toxoplasmosis usually causes no symptoms. Infections in pregnant women, however, can result in brain damage and vision loss in the baby.

### BRIEF DESCRIPTION OF THE INVENTION

In one embodiment, the invention provides a cleaning and disposal system, the system comprising: a liner device having a substantially continuous surface; and at least one perforated device having: a perforated portion having a plurality of openings; and a substantially continuous portion surrounding the perforated portion.

In another embodiment, the invention provides a cleaning and disposal device comprising: a perforated portion; and a substantially continuous portion surrounding the perforated portion.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic view of a litter cleaning and disposal system according to an embodiment of the invention;

FIG. 2 shows a schematic view of a perforated device according to another embodiment of the invention;

FIG. 3 shows a schematic view of a litter cleaning and disposal system according to another embodiment of the invention;

FIG. 4 shows a perspective view of a litter cleaning and disposal system of the invention in combination with a frame device

FIG. 5 shows a schematic view of the use of a litter cleaning and disposal system according to an embodiment of the invention;

FIG. 6 shows a schematic view of a litter cleaning and disposal system according to another embodiment of the invention; and

FIG. 7 shows a cross-sectional side view of the use of a perforated device according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

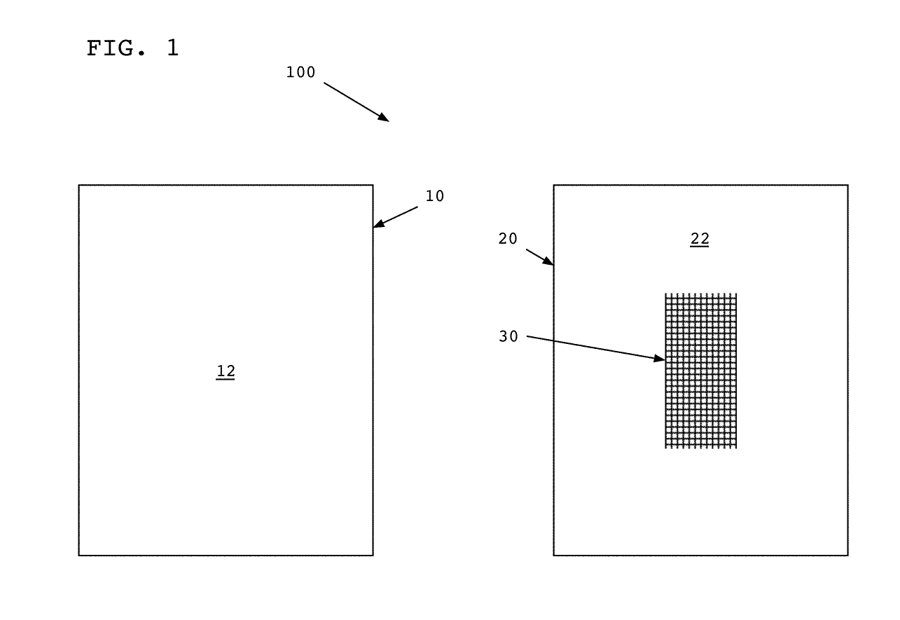

Turning now to the drawings, FIG. 1 shows a schematic view of a litter cleaning and disposal system 100 according to an embodiment of the invention. System 100 includes a liner device 10 having a substantially continuous surface 12. Liner device 10 may be formed from any number of materials, including, for example, polymer materials, such as polyethylene and polypropylene. According to some embodiments of the invention, liner device 10 is formed from or includes a biodegradable material, such as a cellulosic material. These may include, for example, treated or untreated paper materials. Such treated materials may include, for example, waxed paper. Other suitable materials will be apparent to one skilled in the art.

System 100 further includes a perforated device 20 having a perforated portion 30, the periphery of which includes a substantially continuous portion 22. The substantially continuous portion 22 may be formed from or include the same or different material as liner device 10. Perforated portion 30 may include a netting material of the same or a different material as substantially continuous portion 22. Such a netting material may, for example, include a polyethylene or polypropylene material.

Although perforated portion 30 is shown having a rectangular shape in FIG. 1, this is neither necessary nor essential. Other shapes may be employed, including, for example, circular, ovoid, or square shapes. In addition, although perforated portion 30 is shown in FIG. 1 as a net like structure, this too is neither necessary nor essential.

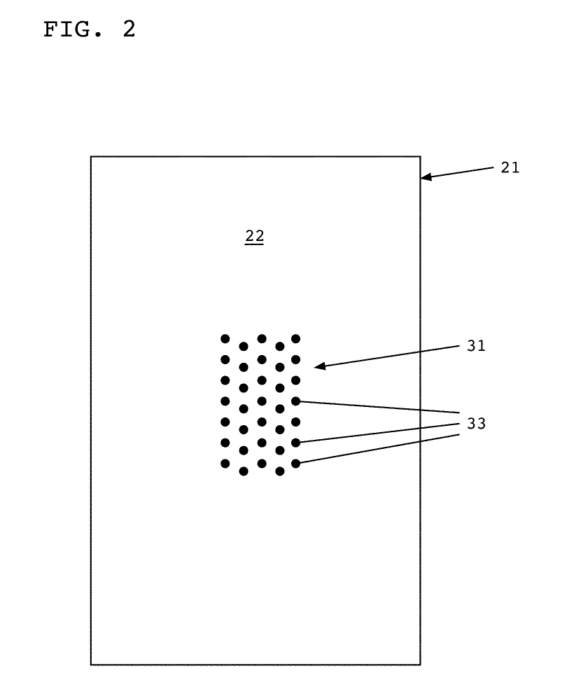

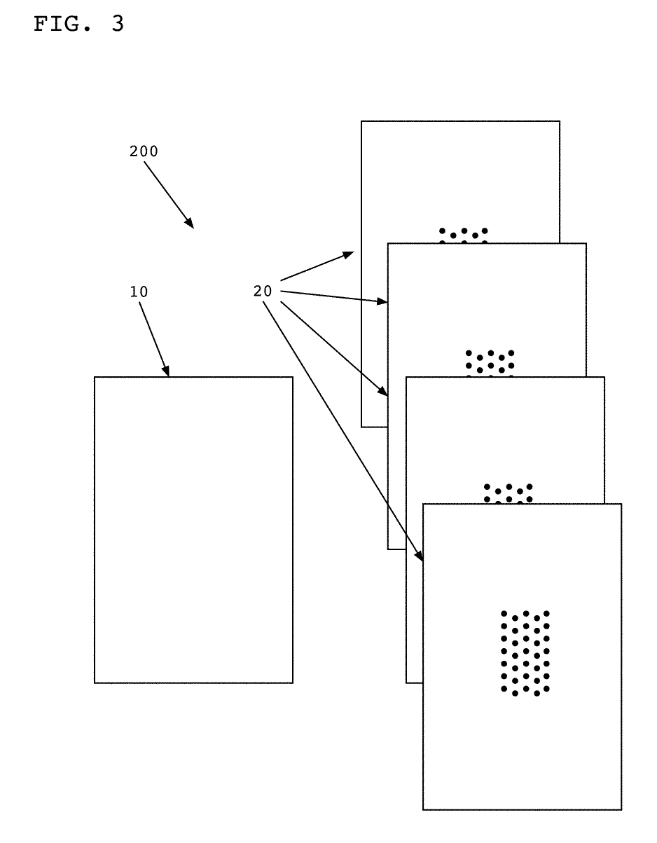

For example, FIG. 2 shows another embodiment of perforated device 20 in which perforated portion 31 comprises a plurality of holes 33 extending through continuous portion 22. FIG. 3 shows a system 200 according to an embodiment of the invention comprising a liner device 10 as described above and a plurality of perforated devices 20.

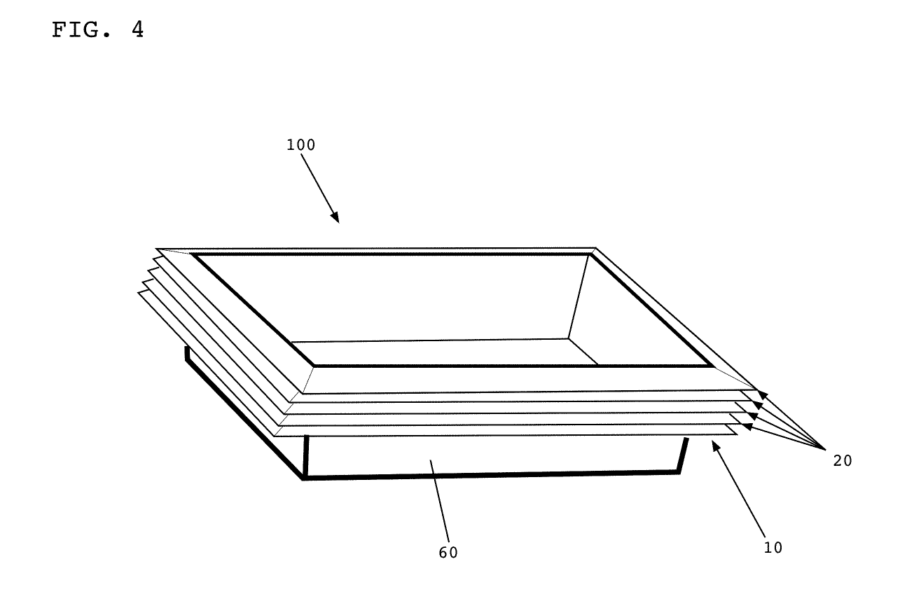

FIG. 4 shows system 200 ready for use. Here, liner device 10 is placed first into or onto a rigid frame device 60 such as a litter box. Then, each of the plurality of perforated devices 20 is disposed atop liner device 10. Litter (not shown) may then be deposited atop the topmost perforated device 20.

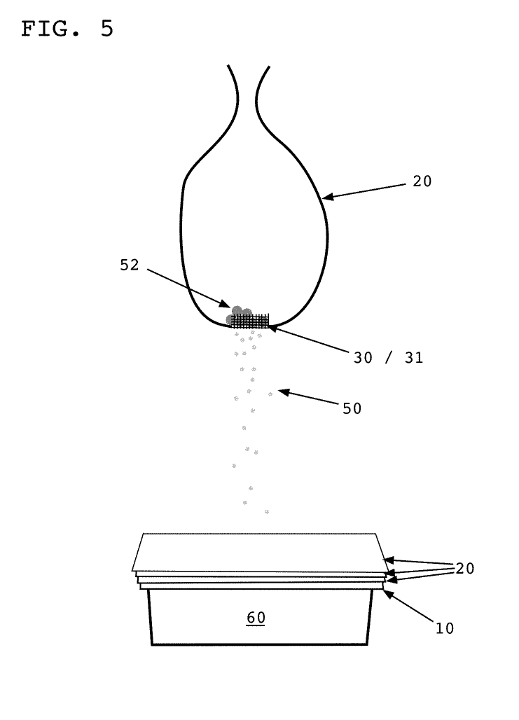

When it is time to clean the litter, the topmost perforated device 20 is lifted from frame device 60, as shown in FIG. 5. Unsoiled litter 50 passes through perforated portion 30, 31. Soiled litter 52, which is clumped, is of a size too large to pass through perforated portion 30, 31 and is retained within the lifted perforated device 20. This minimizes waste in the disposal of unsoiled litter 50, which falls back into frame device 60. This process may then be repeated periodically, with the next perforated device lifted from frame device 60. When only liner device 10 remains beneath the litter and within or atop frame device 60, all litter, both soiled and unsoiled, may be removed for disposal. Typically, a system according to embodiments of the invention will include one liner device 10 and between one and six perforated devices 20.

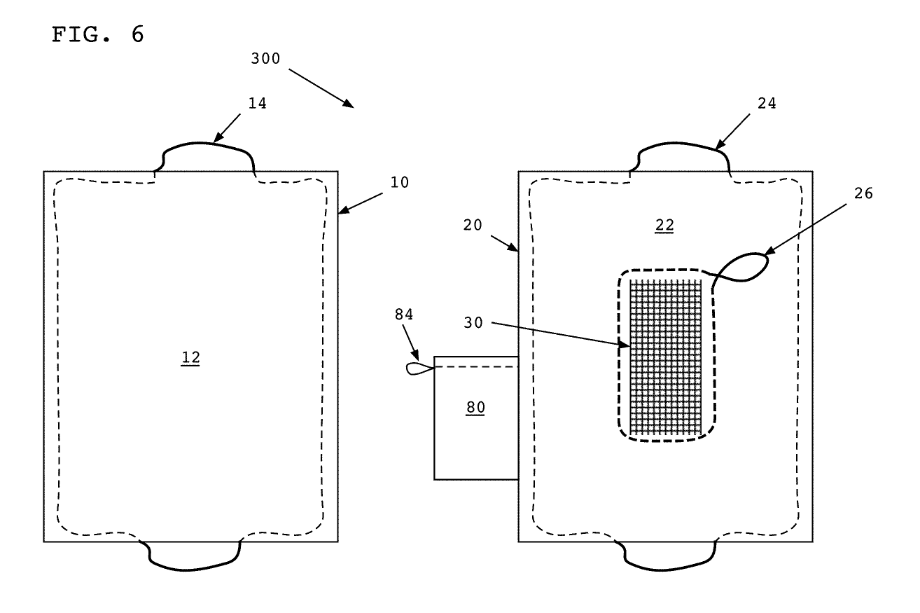

FIG. 6 shows a system 300 according to another embodiment of the invention. Here, liner device 10 and perforated device 20 further include drawstrings 14, 24, respectively. These may aid in the removal of liner device 10 and perforated device 20 from a litter box or similar device, as in a manner similar to the removal of a trash bag from a trash can.

Optionally, according to some embodiments of the invention, system 300 may include a disposal device 80, such as a small bag into which perforated device 20 may be placed for disposal. Disposal device 80 may optionally include its own drawstring 84. In some embodiments of the invention, disposal device 80 may be non-fixedly attached to perforated device 20 using, for example, an adhesive. In other embodiments of the invention, disposal device 80 may be incorporated into or formed as part of perforated device 20. In either case, disposal device 80 may be formed from the same material as perforated device 20.

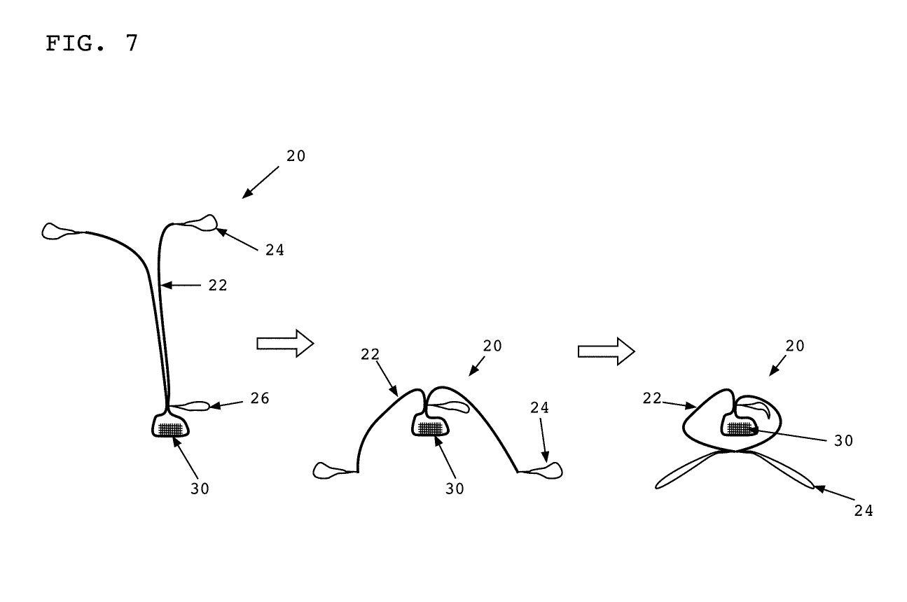

In still other embodiments of the invention, perforated device 20 may further include a second drawstring 26 about the periphery of perforated portion 30. Second drawstring 26 may facilitate disposal of perforated device 20, as shown, for example, in cross-sectional side view in FIG. 7. Here, upon lifting perforated device 20 from frame device 60 (FIG. 5), second drawstring 26 is tightened around perforated portion 30. Next, substantially continuous portion 22 is wrapped around perforated portion 30. Then, drawstring 24 is drawn to secure perforated portion 30 containing soiled litter for disposal.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cleaning and disposal system, the system comprising:
a liner device having a substantially continuous surface; and
at least one perforated device having:
a perforated portion having a plurality of openings; and
a substantially continuous portion surrounding the perforated portion.

2. The cleaning and disposal system of claim 1, further comprising:
a disposal device for the at least one perforated device.

3. The cleaning and disposal system of claim 1, further comprising:
a drawstring along a periphery of the substantially continuous portion of the at least one perforated device.

4. The cleaning and disposal system of claim 1, further comprising:
a drawstring along a periphery of the perforated portion of the at least one perforated device.

5. The cleaning and disposal system of claim 1, wherein the perforated portion has a shape selected from a group consisting of: circular, ovoid, rectangular, and square.

6. The cleaning and disposal system of claim 1, wherein the perforated portion comprises a netting material.

7. The cleaning and disposal system of claim 1, wherein the perforated portion and the substantially continuous portion are composed of the same material, the perforated portion including a plurality of openings.

8. The cleaning and disposal system of claim 1, wherein the at least one perforated device includes a plurality of perforated devices.

9. The cleaning and disposal system of claim 8, wherein each of the plurality of perforated devices includes a disposal device fixedly or non-fixedly attached thereto.

10. The cleaning and disposal system of claim 1, further comprising:
a rigid frame device adapted to support the liner device and the at least one perforated device.

11. A cleaning and disposal device comprising:
a perforated portion; and
a substantially continuous portion surrounding the perforated portion.

12. The cleaning and disposal device of claim 11, further comprising:
a disposal device fixedly or non-fixedly attached to the substantially continuous portion.

13. The cleaning and disposal device of claim 11, further comprising:
a drawstring along a periphery of the substantially continuous portion.

14. The cleaning and disposal device of claim 11, further comprising:
a drawstring along a periphery of the perforated portion.

15. The cleaning and disposal device of claim 11, wherein the perforated portion has a shape selected from a group consisting of: circular, ovoid, rectangular, and square.

16. The cleaning and disposal system of claim 11, wherein the perforated portion comprises a netting material.

17. The cleaning and disposal system of claim 11, wherein the perforated portion and the substantially continuous portion are composed of the same material, the perforated portion including a plurality of openings.
